(19) United States
(12) Patent Application Publication
(10) Pub. No.: US 2003/0160747 A1
(43) Pub. Date: Aug. 28, 2003

(54) Display device, method of driving the same, and electronic equipment

(75) Inventor: Akira Morita, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/357,450

(22) Filed: Feb. 4, 2003

(30) Foreign Application Priority Data
Feb. 8, 2002 (JP) 2002-032676

(51) Int. Cl. G09G 5/00

(52) U.S. Cl. 345/87

(57) ABSTRACT

(N+j)th (1≦j≦N, N and j are integers) and (2N+j)th scan electrodes are disposed corresponding to a jth scan electrode. An (M+k)th (1≦k≦M, M and k are integers) signal electrode and a kth electrode are disposed corresponding to a kth signal electrode. A first pixel switch element connects a pixel electrode with the kth signal electrode based on a voltage of the jth scan electrode. A second pixel switch element connects the pixel electrode with the (M+k)th signal electrode based on a voltage of the (N+j)th scan electrode. A switch element connects the pixel electrode with the kth electrode based on a voltage of the (2N+j)th scan electrode.

Japanese Patent Application No. 2002-32676 filed on Feb. 8, 2002, is hereby incorporated by reference in its entirety.

### BACKGROUND OF THE INVENTION

The present invention relates to a display device, a method of driving the same, and electronic equipment.

A thin film transistor (hereinafter abbreviated as “TFT”) liquid crystal device (display device in a broad sense) is mainly driven by using an alternating current (AC) drive method such as a frame inversion drive method, a line inversion drive method, and a dot inversion drive method. In particular, the dot inversion drive method is capable of effectively preventing occurrence of a flicker.

### BRIEF SUMMARY OF THE INVENTION

According to the first aspect of the present invention, there is provided a display device comprising:

first to Nth (N is an integer of two or more) scan electrodes;

first to Mth (M is an integer of two or more) signal electrodes intersecting the first to Nth scan electrodes;

pixels disposed corresponding to intersecting points of the first to Nth scan electrodes and the first to Mth signal electrodes;

(M+1) th to 2Mth signal electrodes disposed to form pairs with the first to Mth signal electrodes respectively;

(N+1)th to 2Nth scan electrodes disposed corresponding to the first to Nth scan electrodes; and

(2N+1) th to 3Nth scan electrodes disposed corresponding to the first to Nth scan electrodes,

wherein one of the pixels disposed corresponding to an intersecting point of a jth (1≦j≦N, j is an integer) scan electrode among the first to Nth scan electrodes and a kth (1≦k≦M, k is an integer) signal electrode among the first to Mth signal electrodes comprises:

a pixel electrode;

a first pixel switch element being connected with the jth scan electrode and the kth signal electrode, and electrically connecting the kth signal electrode with the pixel electrode based on a voltage of the jth scan electrode;

a second pixel switch element being connected with an (N+j) th scan electrode among the (N+1)th to 2Nth scan electrodes and an (M+k) th signal electrode among the (M+1) th to 2Mth signal electrodes, and electrically connecting the (M+k)th signal electrode with the pixel electrode based on a voltage of the (N+j)th scan electrode; and

a switch element being provided between a kth electrode and the pixel electrode, and electrically connecting the kth electrode with the pixel electrode based on a voltage of the (2N+j)th scan electrode, the kth electrode being disposed corresponding to the kth signal electrode and being supplied with a given first voltage, and

wherein a voltage of the pixel electrode is set at a voltage of the kth electrode through the switch element, and then set at a voltage of one of the kth and (M+k)th signal electrodes through one of the first and second pixel switch element in a given select period.

According to the second aspect of the present invention, there is provided a display device comprising:

first to Nth (N is an integer of two or more) scan electrodes;

first to Mth (M is an integer of two or more) signal electrodes intersecting the first to Nth scan electrodes;

pixels disposed corresponding to intersecting points of the first to Nth scan electrodes and the first to Mth signal electrodes;

(M+1) th to 2Mth signal electrodes disposed to form pairs with the first to Mth signal electrodes respectively; and

(N+1)th to 2Nth scan electrodes disposed corresponding to the first to Nth scan electrodes,

wherein one of the pixels disposed corresponding to an intersecting point of a jth (1≦j≦N, j is an integer) scan electrode among the first to Nth scan electrodes and a kth (1≦k≦M, k is an integer) signal electrode among the first to Mth signal electrodes comprises:

a pixel electrode;

a first pixel switch element being connected with the jth scan electrode and the kth signal electrode, and electrically connecting the kth signal electrode with the pixel electrode based on a voltage of the jth scan electrode; and

a second pixel switch element being connected with an (N+j)th scan electrode among the (N+1) th to 2Nth scan electrodes and an (M+k)th signal electrode among the (M+1) th to 2Mth signal electrodes, and electrically connecting the (M+k)th signal electrode with the pixel electrode based on a voltage of the (N+j)th scan electrode, and

wherein a voltage of the pixel electrode is set at a given intermediate voltage by turning ON the first and second pixel switch elements, and then set at a voltage of one of the kth and (M+k)th signal electrodes through one of the first and second pixel switch elements in a given select period.

According to the third aspect of the present invention, there is provided a display device comprising:

first to Nth (N is an integer of two or more) scan electrodes;

first to Mth (M is an integer of two or more) signal electrodes intersecting the first to Nth scan electrodes;

pixels disposed corresponding to intersecting points of the first to Nth scan electrodes and the first to Mth signal electrodes; and

(2N+1)th to 3Nth scan electrodes disposed corresponding to the first to Nth scan electrodes,

wherein one of the pixels disposed corresponding to an intersecting point of a jth (1≦j≦N, j is an integer) scan electrode among the first to Nth scan electrodes and a kth (1≦k≦M, k is an integer) signal electrode among the first to Mth signal electrodes comprises:

a pixel electrode;

a first pixel switch element being connected with the jth scan electrode and the kth signal electrode, and electrically connecting the kth signal electrode with the pixel electrode based on a voltage of the jth scan electrode; and

a switch element being provided between a kth electrode and the pixel electrode, and electrically connecting the kth electrode with the pixel electrode based on a voltage of the (2N+j)th scan electrode, the kth electrode being disposed corresponding to the kth signal electrode and being supplied with a given first voltage, and

wherein a voltage of the pixel electrode is set at a voltage of the kth electrode through the switch element, and then set at a voltage of the kth signal electrode through the first pixel switch element in a given select period.

According to the fourth aspect of the present invention, there is provided a method of driving a display device, the display device including:

first to Nth (N is an integer of two or more) scan electrodes;

first to Mth (M is an integer of two or more) signal electrodes which intersect the first to Nth scan electrodes;

pixel electrodes disposed corresponding to intersecting points of the first to Nth scan electrodes and the first to Mth signal electrodes; and

first pixel switch elements electrically connecting the first to Mth signal electrodes with the pixel electrodes based on voltages of the first to Nth scan electrodes, the method comprising:

setting one of the pixel electrodes of a pixel disposed corresponding to an intersecting point of a jth (1≦j≦N, j is an integer) scan electrode among the first to Nth scan electrodes and a kth (1≦k≦M, k is an integer) signal electrode among the first to Mth signal electrodes at a first voltage, and then setting the pixel electrode of the pixel at a voltage of the kth signal electrode based on a voltage of the jth scan electrode in a given select period.

### BRIEF DESCRIPTION OF THE SEVERAL VIEWS OF THE DRAWING

FIG. 1 is a configuration diagram showing an outline of a configuration of a liquid crystal device.

FIGS. 2A and 2B are explanatory diagrams for describing a dot inversion drive method.

FIG. 3 is a configuration diagram showing an outline of a configuration of a liquid crystal device in a first embodiment.

FIG. 4 is a configuration diagram of pixels of the liquid crystal device in the first embodiment.

FIG. 5A is a timing chart of a select signal supplied to each scan electrode in the case of changing voltage applied to a liquid crystal of the pixel from negative to positive in the first embodiment; and FIG. 5B is a timing chart of the select signal supplied to each scan electrode in the case of changing voltage applied to the liquid crystal of the pixel from positive to negative in the first embodiment.

FIG. 6 is an explanatory diagram schematically showing a change in voltage of a pixel electrode in the case of changing the voltage applied to the liquid crystal of the pixel from positive to negative in the first embodiment.

FIG. 7 is a configuration diagram showing an outline of a configuration of a liquid crystal device in a second embodiment.

FIG. 8 is a configuration diagram of pixels of the liquid crystal device in the second embodiment.

FIG. 9A is a timing chart of a select signal supplied to each scan electrode in the case of changing voltage applied to a liquid crystal of the pixel from negative to positive in the second embodiment; and FIG. 9B is a timing chart of the select signal supplied to each scan electrode in the case of changing the voltage applied to the liquid crystal of the pixel from positive to negative in the second embodiment.

FIG. 10 is an explanatory diagram schematically showing a change in voltage of a pixel electrode in the case of changing the voltage applied to the liquid crystal of the pixel from positive to negative in the second embodiment.

FIG. 11 is a configuration diagram showing an outline of a configuration of a liquid crystal device in a third embodiment.

FIG. 12 is a configuration diagram of pixels of a liquid crystal device in the third embodiment.

FIG. 13 is an explanatory diagram schematically showing a change in voltage of a pixel electrode in the case of changing voltage applied to a liquid crystal of the pixel from positive to negative in the third embodiment.

FIG. 14 is a view showing an example of a functional block diagram of electronic equipment formed by using a liquid crystal device.

### DETAILED DESCRIPTION OF THE EMBODIMENT

Embodiments of the present invention are described below. However, the embodiments described below should not be construed as limiting the scope of the present invention described in the claims. The entire configuration described below is not necessarily indispensable for the present invention.

In the dot inversion drive method, the polarity of voltage applied to a liquid crystal is alternately reversed for each pixel. Therefore, a common electrode voltage Vcom, a voltage Vp at which the voltage applied to the liquid crystal becomes positive, or a voltage Vm at which the voltage applied to the liquid crystal becomes negative is applied to a signal electrode according to AC drive timing, and written into a pixel capacitance (liquid crystal capacitance). This makes it necessary to drive the voltage to be applied to the signal electrode each time AC drive is performed, whereby power consumption is increased.

According to the following embodiments, a display device, a method of driving the same, and electronic equipment, capable of preventing an increase in power consumption accompanied by AC drive can be provided.

One embodiment of the present invention relates to a display device comprising:

first to Nth (N is an integer of two or more) scan electrodes;

first to Mth (M is an integer of two or more) signal electrodes intersecting the first to Nth scan electrodes;

pixels disposed corresponding to intersecting points of the first to Nth scan electrodes and the first to Mth signal electrodes;

(M+1)th to 2Mth signal electrodes disposed to form pairs with the first to Mth signal electrodes respectively;

(N+1)th to 2Nth scan electrodes disposed corresponding to the first to Nth scan electrodes; and

(2N+1) th to 3Nth scan electrodes disposed corresponding to the first to Nth scan electrodes,

wherein one of the pixels disposed corresponding to an intersecting point of a jth (1≦j≦N, j is an integer) scan electrode among the first to Nth scan electrodes and a kth (1≦k≦M, k is an integer) signal electrode among the first to Mth signal electrodes comprises:

a pixel electrode;

a first pixel switch element being connected with the jth scan electrode and the kth signal electrode, and electrically connecting the kth signal electrode with the pixel electrode based on a voltage of the jth scan electrode;

a second pixel switch element being connected with an (N+j) th scan electrode among the (N+1) th to 2Nth scan electrodes and an (M+k)th signal electrode among the (M+1) th to 2Mth signal electrodes, and electrically connecting the (M+k)th signal electrode with the pixel electrode based on a voltage of the (N+j)th scan electrode; and

a switch element being provided between a kth electrode and the pixel electrode, and electrically connecting the kth electrode with the pixel electrode based on a voltage of the (2N+j)th scan electrode, the kth electrode being disposed corresponding to the kth signal electrode and being supplied with a given first voltage, and

wherein a voltage of the pixel electrode is set at a voltage of the kth electrode through the switch element, and then set at a voltage of one of the kth and (M+k)th signal electrodes through one of the first and second pixel switch element in a given select period.

According to this embodiment, in the display device comprising the first to Nth scan electrodes, the first to Mth signal electrodes, and the pixels disposed corresponding to the intersecting points of the first to Nth scan electrodes and the first to Mth signal electrodes, the voltage of the pixel electrode of the pixel disposed corresponding to the intersecting point of the jth scan electrode and the kth signal electrode is set at the first voltage supplied to the kth electrode through the switch element in the given select period. The voltage of the pixel electrode is then set at the voltage of the kth signal electrode or the voltage of the (M+k) th signal electrode which is disposed to form a pair with the kth signal electrode.

This enables charges stored in the pixels arranged in a line to be transferred simultaneously, whereby the voltages of the pixel electrodes can be uniformly set at the first voltage without an external current in a former period of the select period. Therefore, only driving a signal electrode from the first voltage to either a positive or a negative voltage is necessary, and alternately driving a signal electrode between a positive and a negative voltages in AC drive is unnecessary. As a result, power consumption accompanied by AC drive can be decreased.

In this display device, voltages supplied to the kth and (M+k) th signal electrodes may be polarity-reversed on the basis of a potential of a common electrode provided facing to the pixel electrode.

According to this embodiment, it is unnecessary to frequently change the voltages of the kth and (M+k)th signal electrodes according to AC drive timing, whereby power consumption accompanied by driving the signal electrode can be decreased.

Another embodiment of the present invention relates to a display device comprising:

first to Nth (N is an integer of two or more) scan electrodes;

first to Mth (M is an integer of two or more) signal electrodes intersecting the first to Nth scan electrodes;

pixels disposed corresponding to intersecting points of the first to Nth scan electrodes and the first to Mth signal electrodes;

(M+1) th to 2Mth signal electrodes disposed to form pairs with the first to Mth signal electrodes respectively; and

(N+1)th to 2Nth scan electrodes disposed corresponding to the first to Nth scan electrodes,

wherein one of the pixels disposed corresponding to an intersecting point of a jth (1≦j≦N, j is an integer) scan electrode among the first to Nth scan electrodes and a kth (1≦k≦M, k is an integer) signal electrode among the first to Mth signal electrodes comprises:

a pixel electrode;

a first pixel switch element being connected with the jth scan electrode and the kth signal electrode, and electrically connecting the kth signal electrode with the pixel electrode based on a voltage of the jth scan electrode; and

a second pixel switch element being connected with an (N+j)th scan electrode among the (N+1) th to 2Nth scan electrodes and an (M+k)th signal electrode among the (M+1)th to 2Mth signal electrodes, and electrically connecting the (M+k)th signal electrode with the pixel electrode based on a voltage of the (N+j)th scan electrode, and

wherein a voltage of the pixel electrode is set at a given intermediate voltage by turning ON the first and second pixel switch elements, and then set at a voltage of one of the kth and (M+k) th signal electrodes through one of the first and second pixel switch elements in a given select period.

Since the pixel electrode is electrically connected with the kth and (M+k)th signal electrodes through the first and second pixel switch elements, the given intermediate voltage is determined as an intermediate value between the voltages of the kth or (M+k)th signal electrodes based on the voltages of the kth or (M+k)th signal electrodes, for example.

According to this embodiment, in the display device comprising the first to Nth scan electrodes, the first to Mth signal electrodes, and the pixels disposed corresponding to the intersecting point of the first to Nth scan electrodes and the first to Mth signal electrodes, the voltage of the pixel electrode of the pixel disposed corresponding to the intersecting point of the jth scan electrode and the kth signal electrode is set at the intermediate voltage determined by the voltages of the kth and (M+k)th signal electrodes in the given select period. The voltage of the pixel electrode is then set at the voltage of the kth signal electrode or the voltage of the (M+k)th signal electrode disposed to form a pair with-the kth signal electrode.

This enables charges stored in the pixels arranged in a line to be transferred simultaneously, whereby the voltages of the pixel electrodes can be uniformly set at the given intermediate voltage without an external current in a former period of the select period. Therefore, the above effect can be obtained without providing additional electrodes, whereby the configuration can be further simplified. Moreover, only driving a signal electrode from the intermediate voltage to either a positive or a negative voltage is necessary, and alternately driving a signal electrode between a positive and a negative voltages in AC drive is unnecessary. As a result, power consumption accompanied by AC drive can be decreased.

In this display device, voltages supplied to the kth and (M+k)th signal electrodes maybe polarity-reversed on the basis of a potential of a common electrode provided facing to the pixel electrode.

According to this embodiment, since it is unnecessary to frequently change the voltages of the kth and (M+k)th signal electrodes according to AC drive timing, power consumption accompanied by driving the signal electrodes can be decreased.

Further embodiment of the present invention relates to a display device comprising:

first to Nth (N is an integer of two or more) scan electrodes;

first to Mth (M is an integer of two or more) signal electrodes intersecting the first to Nth scan electrodes;

pixels disposed corresponding to intersecting points of the first to Nth scan electrodes and the first to Mth signal electrodes; and

(2N+1)th to 3Nth scan electrodes disposed corresponding to the first to Nth scan electrodes,

wherein one of the pixels disposed corresponding to an intersecting point of a jth (1≦j≦N, j is an integer) scan electrode among the first to Nth scan electrodes and a kth (1≦k≦M, k is an integer) signal electrode among the first to Mth signal electrodes comprises:

a pixel electrode;

a first pixel switch element being connected with the jth scan electrode and the kth signal electrode, and electrically connecting the kth signal electrode with the pixel electrode based on a voltage of the jth scan electrode; and

a switch element being provided between a kth electrode and the pixel electrode, and electrically connecting the kth electrode with the pixel electrode based on a voltage of the (2N+j)th scan electrode, the kth electrode being disposed corresponding to the kth signal electrode and being supplied with a given first voltage, and

wherein a voltage of the pixel electrode is set at a voltage of the kth electrode through the switch element, and then set at a voltage of the kth signal electrode through the first pixel switch element in a given select period.

According to this embodiment, in the display device comprising the first to Nth scan electrodes, the first to Mth signal electrodes, and the pixels disposed corresponding to the intersecting points of the first to Nth scan electrodes and the first to Mth signal electrodes, the voltage of the pixel electrode of the pixel disposed corresponding to the intersecting point of the jth scan electrode and the kth signal electrode is set at the first voltage supplied to the kth electrode through the switch element in the given select period. The voltage of the pixel electrode is then set at the voltage of the kth signal electrode to which the positive and negative voltages are supplied.

This enables charges stored in the pixels arranged in a line to be transferred simultaneously, whereby the pixel electrodes can be uniformly set at the first voltage without an external current in a former period of the select period. Therefore, the above effect can be obtained without providing additional electrodes, whereby the configuration can be further simplified. Moreover, since the charges can be reutilized, and only driving a signal electrode from the first voltage to either a positive or a negative voltage is necessary, power consumption accompanied by AC drive can be decreased.

In the display device according to this embodiment, the first voltage may be substantially equal to a voltage applied to a common electrode provided facing to the pixel electrode.

According to this embodiment, since electrodes can be disposed in the display device by using the common electrodes provided facing to the pixel electrodes, the configuration can be simplified.

Still another embodiment of the present invention relates to electronic equipment comprises any of the above display devices.

According to this embodiment, electronic equipment in which power consumption accompanied by AC drive is decreased can be provided.

Yet another embodiment of the present invention relates to a method of driving a display device, the display device including:

first to Nth (N is an integer of two or more) scan electrodes;

first to Mth (M is an integer of two or more) signal electrodes which intersect the first to Nth scan electrodes;

pixel electrodes disposed corresponding to intersecting points of the first to Nth scan electrodes and the first to Mth signal electrodes; and

first pixel switch elements electrically connecting the first to Mth signal electrodes with the pixel electrodes based on voltages of the first to Nth scan electrodes,

the method comprising:

setting one of the pixel electrodes of a pixel disposed corresponding to an intersecting point of a jth (1≦j≦N, j is an integer) scan electrode among the first to Nth scan electrodes and a kth (1≦k≦M, k is an integer) signal electrode among the first to Mth signal electrodes at a first voltage, and then setting the pixel electrode of the pixel at a voltage of the kth signal electrode based on a voltage of the jth scan electrode in a given select period.

According to this embodiment, since the voltage of the pixel electrode is set at the first voltage in a former period of the select period without using the kth signal electrode, it is unnecessary to alternately drive the kth signal electrode between a positive and a negative voltages in AC drive. Therefore, only driving the kth signal electrode from the first voltage to either a positive or a negative voltage, thereby power consumption accompanied by AC drive can be decreased.

The embodiments of the present invention are described below in detail with reference to the drawings.

1. Liquid Crystal Device

1.1 Configuration

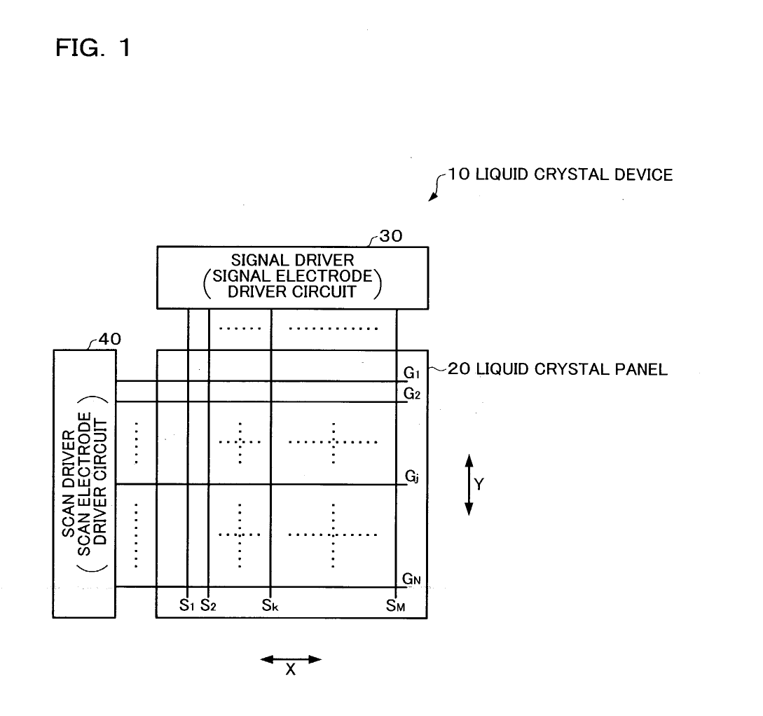

FIG. 1 shows an outline of a configuration of a liquid crystal device.

A liquid crystal device (electro-optical device or display device in abroad sense) 10 is a TFT liquid crystal device. The liquid crystal device 10 includes a liquid crystal panel (display panel in a broad sense) 20.

The liquid crystal panel 20 is formed on a glass substrate, for example. A plurality of first to Nth (N is an integer of two or more) scan electrodes (gate lines) G₁ to G_{N} which are arranged in the Y direction and extend in the X direction, and a plurality of first to Mth (M is an integer of two or more) signal electrodes (source lines) S₁ to S_{M} which are arranged in the X direction and extend in the Y direction are disposed on the glass substrate. Pixels (pixel regions) are disposed in the shape of a matrix corresponding to intersecting points of the first to Nth scan electrodes G₁ to G_{N} and the first to Mth signal electrodes S₁ to S_{M}.

Each pixel includes a TFT as a pixel switch element, and a pixel electrode. Specifically, the pixel corresponding to the intersecting point of the jth (1≦j≦N, j is an integer) scan electrode Gⱼ and the kth (1≦k≦M, k is an integer) signal electrode Sₖ includes a TFT of which a gate electrode is connected with the jth scan electrode Gⱼ and a source terminal is connected with the kth signal electrode Sₖ, and a pixel electrode of a liquid crystal (liquid crystal capacitance or pixel capacitance) (liquid crystal element in a broad sense) which is connected with a drain terminal of the TFT. The liquid crystal capacitance is formed by sealing a liquid crystal between the pixel electrode and a common electrode opposite to the pixel electrode. The transmittance of the pixel is changed corresponding to voltage applied between these electrodes. A common electrode voltage Vcom is supplied to the common electrode.

The liquid crystal device 10 includes a signal driver (signal electrode driver circuit in a broad sense) 30. The signal driver 30 drives the first to Mth signal electrodes S₁, to S_{M} of the liquid crystal panel 20 based on image data.

The liquid crystal device 10 includes a scan driver 40. The scan driver 40 sequentially drives the first to Nth scan electrodes G₁ to G_{N} of the liquid crystal panel 20 within one vertical scanning period.

1.2 AC Drive

In the liquid crystal device 10, AC drive is performed by using a dot inversion drive method in order to prevent a DC component from being continuously applied to the liquid crystal of each pixel and effectively prevent occurrence of a flicker. In AC drive, the signal electrode is driven so that the polarity of the voltage applied to the liquid crystal is reversed by changing the voltage of the pixel electrode with respect to the common electrode voltage Vcom applied to the common electrode.

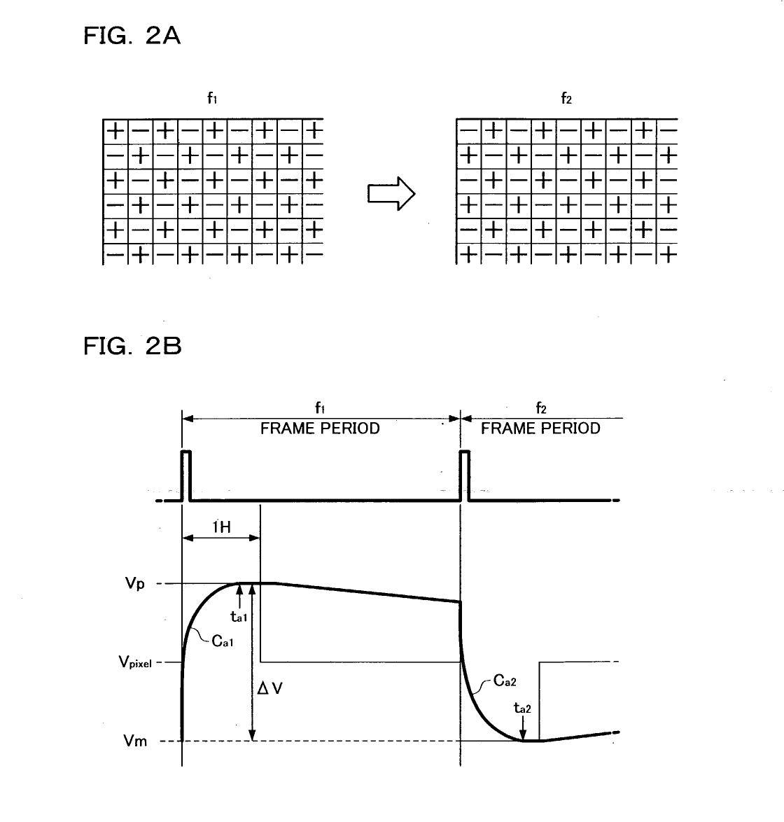

FIGS. 2A and 2B are views for describing the dot inversion drive method.

In the dot inversion drive method, the polarity of the voltage applied to the liquid crystal is alternately reversed for each pixel in a frame unit. The pixels in which the polarity of the voltage applied to the liquid crystal is positive are indicated by “+”, and the pixels in which the polarity of the voltage applied to the liquid crystal is negative are indicated by “−” In the dot inversion drive method, the polarity of the voltage is reversed for each pixel between a frame f₁ and a subsequent frame f₂, as shown in FIG. 2A.

In the pixel in which the polarity of the voltage applied to the liquid crystal is positive in the frame f₁ and becomes negative in the frame f₂, the voltage of the signal electrode of the pixel is changed as shown in FIG. 2B. When a voltage Vp is supplied to the signal electrode of the pixel so that the polarity of the voltage applied to the liquid crystal becomes positive in the frame f₁, the voltage of the signal electrode reaches the voltage Vp at a time tₐ₁ in one horizontal scanning period (select period) along a charge characteristic curve Cₐ₁. When a voltage Vm is supplied so that the polarity of the voltage applied to the liquid crystal becomes negative with respect to the common electrode voltage Vcom in the subsequent frame f₂, the voltage of the signal electrode reaches the voltage Vm at a time tₐ₂ in one horizontal scanning period (select period) along a charge characteristic curve Cₐ₂. In the case of performing such AC drive, since the voltage applied to the signal electrode is changed in an amount equal to a voltage ΔV in each frame, it is necessary to charge or discharge the signal electrode each time the voltage is changed. This results in an increase in power consumption accompanied by driving the signal electrode.

In the following embodiments, in order to reduce such charge and discharge, a liquid crystal device capable of decreasing power consumption accompanied by AC drive is provided by changing the configuration of the pixel.

2. First Embodiment

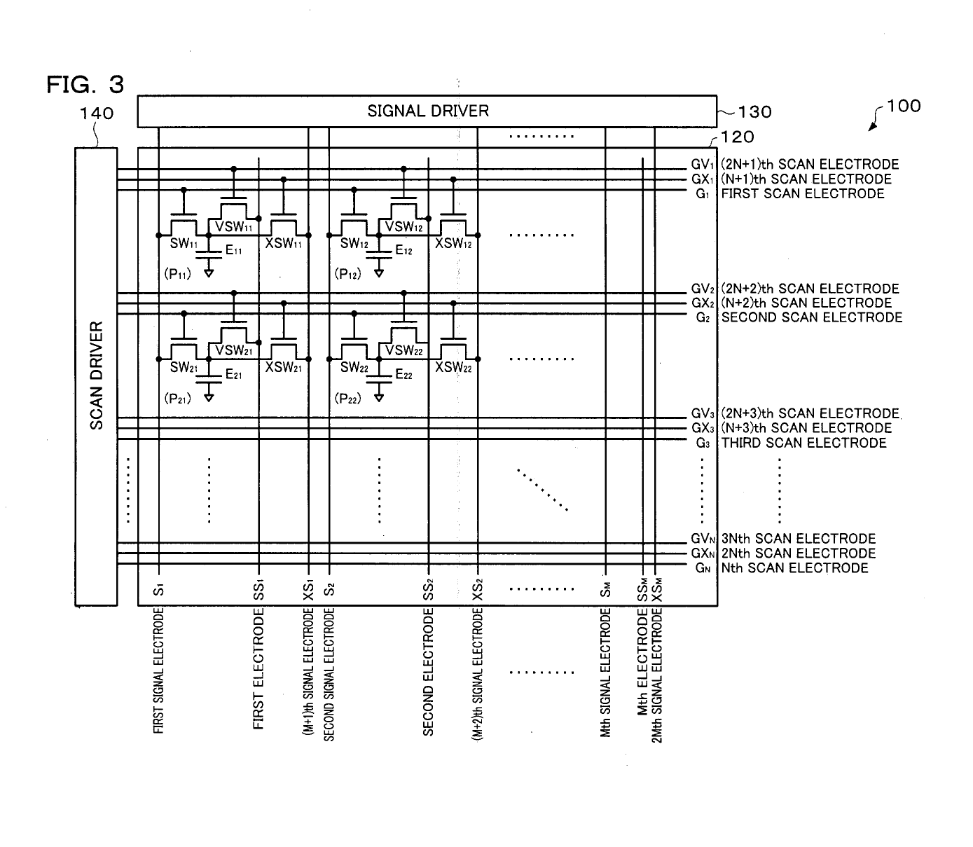

FIG. 3 shows an outline of a configuration of a liquid crystal device in a first embodiment.

A liquid crystal device 100 in the first embodiment may include a liquid crystal panel (display panel in a broad sense) 120.

The liquid crystal panel 120 is formed on a glass substrate, for example. A plurality of first to Nth scan electrodes G₁ to G_{N} which are arranged in the Y direction and extend in the X direction, and a plurality of first to Mth signal electrodes S₁ to S_{M} which are arranged in the X direction and extend in the Y direction are disposed on the glass substrate. (M+1)th to 2Mth signal electrodes XS₁ to XS_{M} (=S_{M+1} to S_{2M}) are disposed to form pairs with each of the first to Mth signal electrodes S₁, to S_{M}. First to Mth electrodes SS₁, to SS_{M} are disposed corresponding to the first to Mth signal electrodes S₁ to S_{M}.

The voltage Vp at which the voltage applied to the liquid crystal of the pixel becomes positive with respect to the common electrode voltage Vcom is supplied to the jth signal electrode Sⱼ among the first to Mth signal electrodes S₁ to S_{M}. The voltage Vm at which the voltage applied to the liquid crystal of the pixel becomes negative with respect to the common electrode voltage Vcom is supplied to the (M+j)th signal electrode XSⱼ (=S_{M+j}) which forms a pair with the jth signal electrode Sⱼ among the (M+1) th to 2Mth signal electrodes XS₁ to XS_{M} (=S_{M+1} to S_{2M}) The common electrode voltage Vcom is supplied to the first to Mth electrodes SS₁ to SS_{M}.

(N+1)th to 2Nth scan electrodes GX₁ to GX_{N} (=G_{N+1} to G_{2N}) are disposed corresponding to each of the first to Nth scan electrodes G₁ to G_{N} so as to be parallel to the first to Nth scan electrodes G₁ to G_{N}, for example. (2N+1)th to 3Nth scan electrodes GV₁ to GV_{N} (=G_{2N+1} to G_{3N}) are disposed corresponding to each of the first to Nth scan electrodes G₁ to G_{N} so as to be parallel to the first to Nth scan electrodes G₁ to G_{N}, for example.

Pixels (pixel regions) are disposed in the shape of a matrix corresponding to the intersecting points of the first to Nth scan electrodes G₁ to G_{N} and the first to Mth signal electrodes S₁, to S_{M}. The pixel corresponding to the intersecting point of the jth scan electrode Gⱼ and the kth signal electrode Sₖ is indicated by Pⱼₖ. Although only the pixels P₁₁, P₁₂, P₂₁, and P₂₂ are illustrated in FIG. 3, other pixels have the same configuration.

The liquid crystal device 100 may include a signal driver 130. The signal driver 130 drives the first to Mth signal electrodes S₁ to S_{M} and the (M+1)th to 2Mth signal electrodes XS₁ to XS_{M} (=S_{M+1} to S_{2M}) of the liquid crystal panel 120 based on image data.

The common electrode voltage Vcom may be applied to the first to Meth electrodes SS₁ to SS_{M} from either the signal driver 130 or a power supply circuit (not shown).

The liquid crystal device 100 may include a scan driver 140. The scan driver 140 drives the first to Nth scan electrodes G₁, to G_{N}, the (N+1)th to 2Nth scan electrodes GX₁ to GX_{N} (=G_{2N+1} to G_{2N}), and the (2N+1)th to 3Nth scan electrodes GV₁ to GV_{N} (=G_{2N+1} to G_{3N}) of the liquid crystal panel 120 within one vertical scanning period.

A circuit functionally equivalent to the signal driver 130 may be formed on the substrate on which the liquid crystal panel 120 is formed. A circuit functionally equivalent to the scan driver 140 may be formed on the substrate.

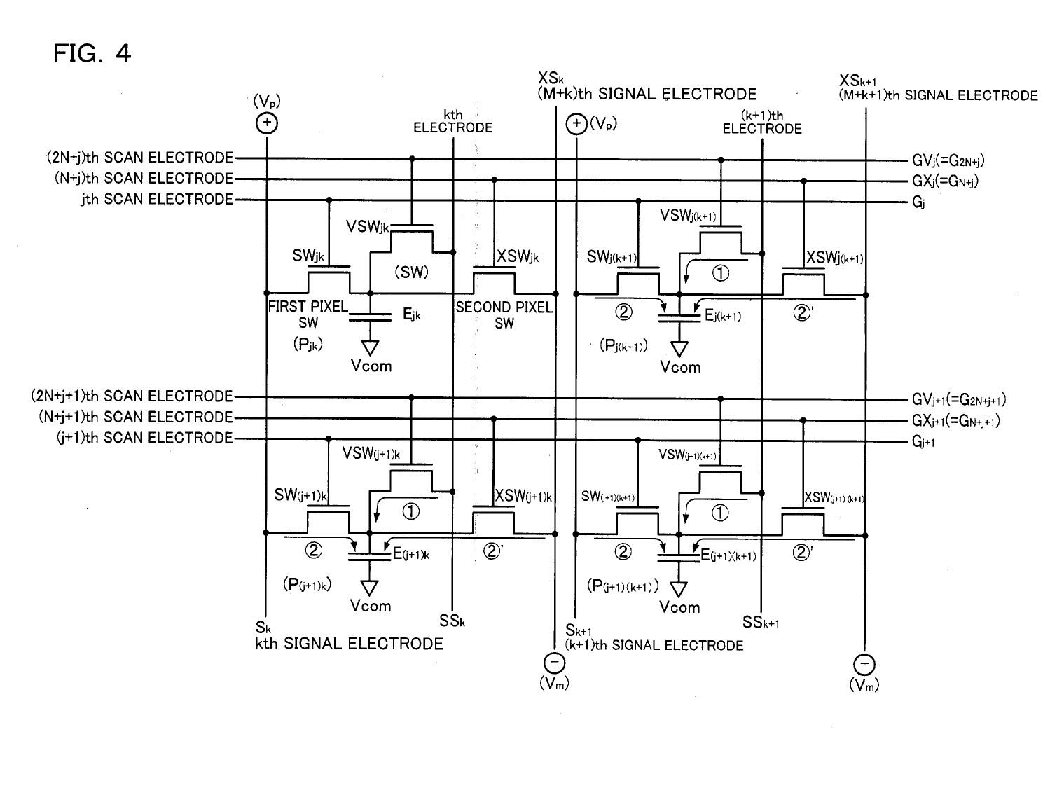

FIG. 4 is a configuration diagram of the pixels of the liquid crystal device in the first embodiment.

In FIG. 4, the pixels Pⱼₖ, Pⱼ₍ₖ₊₁₎, and P₍ⱼ₊₁₎₍ₖ₊₁₎ are illustrated.

The pixel Pⱼₖ includes a first pixel switch element SWⱼₖ and a pixel electrode Eⱼₖ. A gate electrode of the first pixel switch element SWⱼₖ is connected with the jth scan electrode Gⱼ. A source terminal of the first pixel switch element SWⱼₖ is connected with the kth signal electrode Sₖ. A drain terminal of the first pixel switch element SWⱼₖ is connected with the pixel electrode Eⱼₖ. The first pixel switch element SWⱼₖ electrically connects the kth signal electrode Sₖ with the pixel electrode Eⱼₖ based on the voltage of the jth scan electrode Gⱼ. The first pixel switch element SWⱼₖ maybe realized by using a TFT.

The pixel Pⱼₖ may include a second pixel switch element XSWⱼₖ. A gate electrode of the second pixel switch element XSWⱼₖ is connected with the (N+j)th scan electrode GXⱼ (=G_{N+j}). A source terminal of the second pixel switch element XSWⱼₖ is connected with the (M+k)th signal electrode XSₖ (=S_{M+k}) A drain terminal of the second pixel switch element XSWⱼₖ is connected with the pixel electrode Eⱼₖ. The second pixel switch element XSWⱼₖ electrically connects the (M+k)th signal electrode XSₖ (=S_{M+k}) with the pixel electrode Eⱼₖ based on the voltage of the (N+j)th scan electrode GXⱼ (=G_{N+j}). The second pixel switch element XSWⱼₖ may be realized by using a TFT.

The pixel Pⱼₖ may include a switch element VSWⱼₖ. A gate electrode of the switch element VSWⱼₖ is connected with the (2N+j)th scan electrode GVⱼ (=G_{2N+j}). A source terminal of the switch element VSWⱼₖ is connected with the kth electrode SSₖ. drain terminal of the switch element VSWⱼₖ is connected with the pixel electrode Eⱼₖ. The switch element VSWⱼₖ electrically connects the kth electrode SSₖ with the pixel electrode Eⱼₖ based on the voltage of the (2N+j)th scan electrode GV_{j (=G}_{2N+j}). The switch element VSWⱼₖ may be realized by using a TFT.

A liquid crystal capacitance is formed by sealing a liquid crystal between the pixel electrode Eⱼₖ and the common electrode opposite to the pixel electrode Eⱼₖ. The transmittance of the pixel is changed corresponding to the voltage applied between these electrodes. The common electrode voltage Vcom is supplied to the common electrode.

In this configuration, in the case of changing the voltage of the pixel electrode Eⱼₖ according to AC drive timing, the switch element VSWⱼₖ is turned ON by supplying a select signal to the (2N+j)th scan electrode GVⱼ (=G_{2N+j}) in a first period of a given select period. This allows the pixel electrode Eⱼₖ to be electrically connected with the kth electrode SSₖ. Therefore, the voltage of the pixel electrode Eⱼₖ is set at the common electrode voltage Vcom (first voltage in a broad sense).

The first pixel switch element SWⱼₖ or the second pixel switch element XSWⱼₖ is then turned ON by supplying the select signal to the jth scan electrode Gⱼ or the (N+j) th scan electrode GXⱼ (=G_{N+j}), whereby the pixel electrode Eⱼₖ is electrically connected with the kth signal electrode Sₖ or the (M+k) th signal electrode XSₖ (=S_{M+k}).

In this example, the voltage of the pixel electrode Eⱼₖ is set at the common electrode voltage Vcom. However, the voltage of the pixel electrode Eⱼₖ may be set at a voltage shifted to the positive side or the negative side, taking charge and discharge characteristics of the signal electrode into consideration. This enables the charge time of the pixel electrode Eⱼₖ to be effectively decreased.

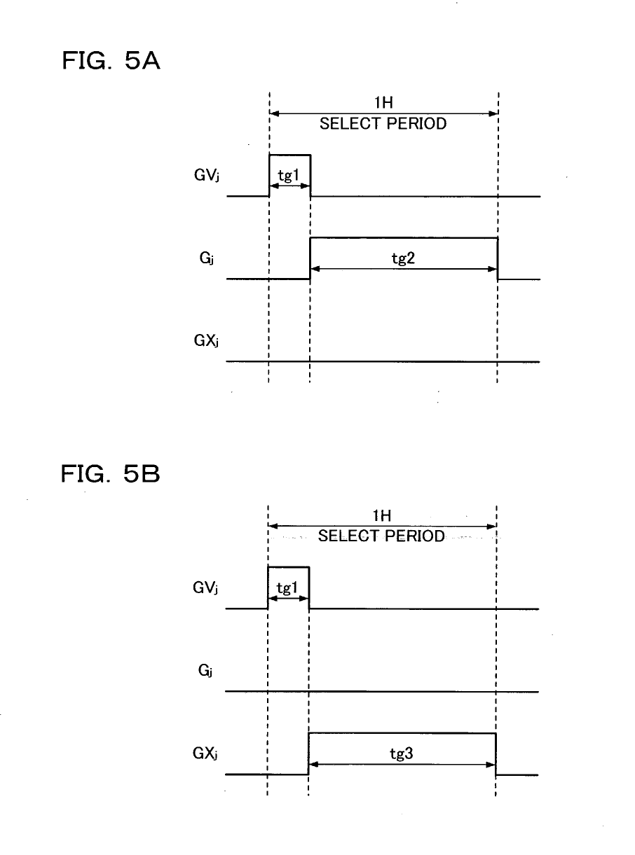

FIG. 5A shows a timing chart of the select signal supplied to each scan electrode in the case of changing the voltage applied to the liquid crystal of the pixel from negative to positive.

The select signal having a pulse width of tg1 is supplied to the (2N+j)th scan electrode GVⱼ (=G_{2N+j}) in a first period of one horizontal scanning period 1H (given select period in a broad sense). This allows the switch element VSWⱼₖ to be turned ON, whereby the voltage of the pixel electrode Eⱼₖ is set at the common electrode voltage Vcom. The select signal having a pulse width of tg2 is supplied to the jth scan electrode Gⱼ when the time tg1 has elapsed after one horizontal scanning period is started. This allows the first pixel switch element SWⱼₖ to be turned ON, whereby the voltage of the pixel electrode Eⱼₖ is set at the voltage Vp of the kth signal electrode Sₖ.

It is preferable that the pulse width tg₁ be smaller than the pulse width tg₂, taking drive capability for each electrode into consideration.

FIG. 5B shows a timing chart of the select signal supplied to each scan electrode in the case of changing the voltage applied to the liquid crystal of the pixel from positive to negative.

The select signal having a pulse width of tg1 is supplied to the (2N+j)th scan electrode GVⱼ (=G_{2N+j}) in the first period of one horizontal scanning period 1H (given select period in a broad sense). This allows the switch element VSWⱼₖ to be turned ON, whereby the voltage of the pixel electrode Eⱼₖ is set at the common electrode voltage Vcom. The select signal having a pulse width of tg₃ is supplied to the (N+j)th scan electrode GXⱼ (=G_{N+j}) when the time tg1 has elapsed after one horizontal scanning period is started. This allows the second pixel switch element XSWⱼₖ to be turned ON, whereby the voltage of the pixel electrode Eⱼₖ is set at the voltage Vm of the (M+k) th signal electrode XSₖ (=S_{M+k}).

It is preferable that the pulse width tg1 be smaller than the pulse width tg3, taking drive capability for each electrode into consideration.

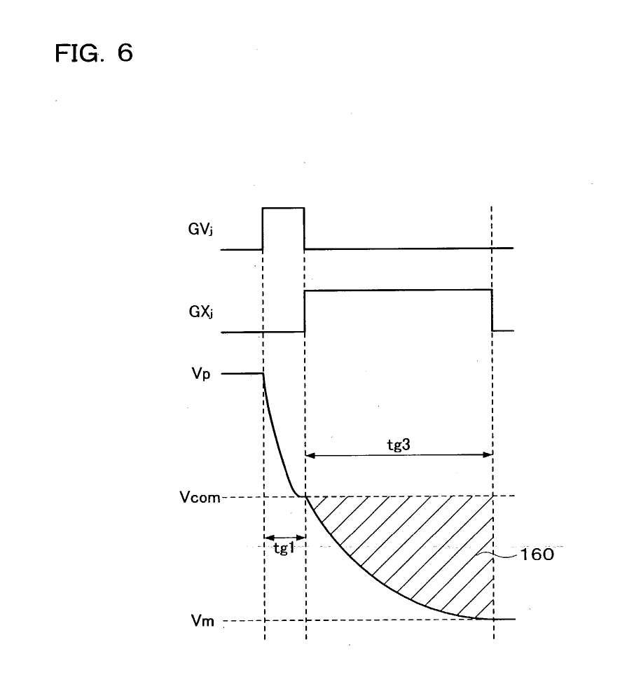

FIG. 6 schematically shows a change in voltage of the pixel electrode Eⱼₖ in the case of changing the voltage applied to the liquid crystal of the pixel from positive to negative.

The voltage of the pixel electrode Eⱼₖ is set at the common electrode voltage Vcom before the time tg1 elapses after the select period is started. When the second pixel switch element XSWⱼₖ is turned ON, the pixel electrode Eⱼₖ is set at the voltage Vm of the (M+k)th signal electrode XSₖ (=S_{M+k}).

Charges stored in all the pixels connected with one scan electrode are extracted into the common electrodes by allowing the first to Mth electrodes SS₁ to SS_{M} to be electrically connected with the common electrodes. Therefore, the pixel electrodes can be uniformly set at the common electrode voltage Vcom by only transferring charges in the liquid crystal panel 120 without allowing current from the outside to flow. Specifically, since it suffices that charges corresponding to slanted lines 160 be discharged, it is unnecessary to discharge the charges from the voltage Vp to the voltage Vm. This also applies to the case of changing the voltage from negative to positive. As described above, since it suffices that the signal electrode be charged or discharged from the common electrode voltage Vcom to either the voltage Vp or the voltage Vm, power consumption accompanied by AC drive can be decreased.

In addition, it is unnecessary to perform inversion processing of the image data at AC drive timing in the signal driver 130 by separately providing the signal electrodes for positive and negative voltages. Therefore, the configuration of the signal driver 130 can be simplified.

3. Second Embodiment

In the liquid crystal device 100 in the first embodiment, the pixel electrodes are set at the common electrode voltage Vcom by providing the switch element in each pixel. However, the present invention is not limited thereto. A liquid crystal device in a second embodiment has a configuration in which the switch element is removed from each pixel. This enables a configuration in which the first to Mth electrodes SS₁ to SS_{M} and the (2N+1)th to 3Nth scan electrodes GV₁ to GV_{N} (=G_{2N+1} to G_{3N}) which ON-OFF control the switch elements are omitted to be realized.

A liquid crystal device in the second embodiment is described below in detail.

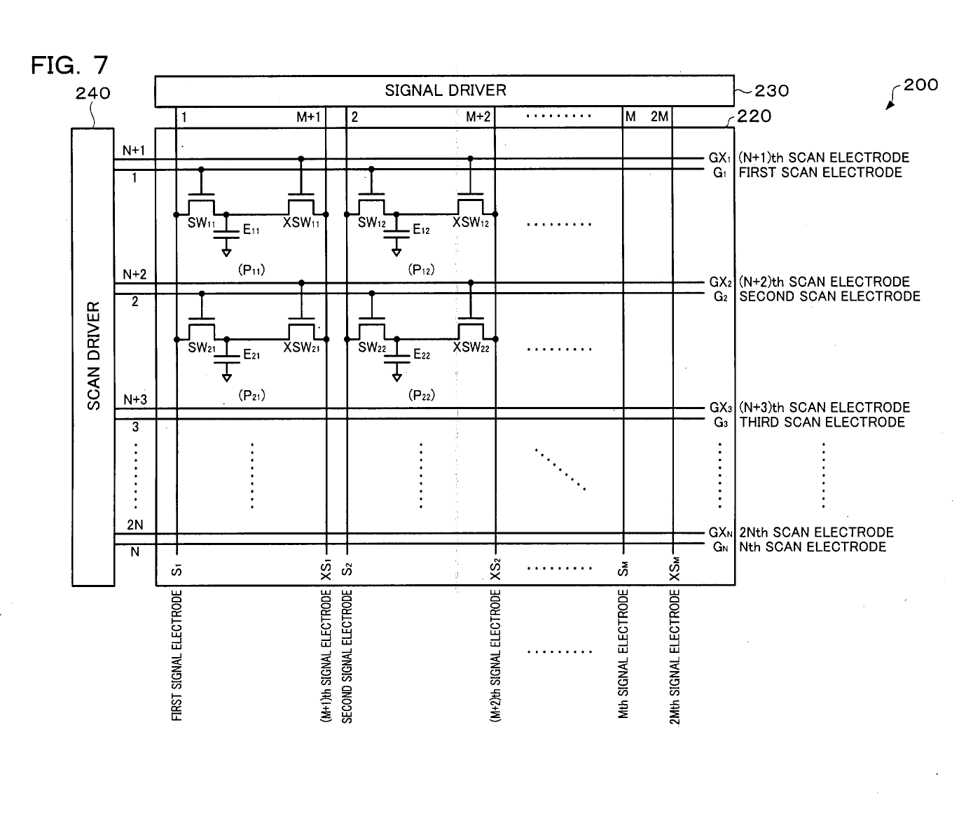

FIG. 7 shows an outline of a configuration of a liquid crystal device in the second embodiment.

A liquid crystal device 200 in the second embodiment may include a liquid crystal panel (display panel in a broad sense) 220.

A first feature of the liquid crystal panel 220 differing from the liquid crystal panel 120 of the liquid crystal device 100 in the first embodiment is that the first to Mth electrodes SS₁, to SS_{M} are removed. A second feature is that the (2N+1)th to 3Nth scan electrodes GV₁ to GV_{N} (=G_{2N+1} to G_{3N}) are removed. A third feature is that the switch elements VSW₁₁ to VSW_{NM} are removed from the pixels P₁₁ to P_{NM}.

In the liquid crystal panel 220, the pixels (pixel regions) are disposed in the shape of a matrix corresponding to intersecting points of the first to Nth scan electrodes G₁ to G_{N} and the first to Mth signal electrodes S₁ to S_{M} in the same manner as in the liquid crystal panel 120 in the first embodiment.

The pixel corresponding to the intersecting point of the jth scan electrode Gⱼ and the kth signal electrode Sₖ is indicated by Pⱼₖ. Although only the pixels P₁₁, P₁₂, P₂₁, and P₂₂ are illustrated in FIG. 7, other pixels have the same configuration.

The liquid crystal device 200 may include a signal driver 230. The signal driver 230 drives the first to Mth signal electrodes S₁ to S_{M} and the (M+1)th to 2Mth signal electrodes XS₁ to XS_{M} (=S_{M+1} to S_{2M}) of the liquid crystal panel 220 based on image data.

The liquid crystal device 200 may include a scan driver 240. The scan driver 240 drives the first to Nth scan electrodes G₁ to G_{N} and the (N+1)th to 2Nth scan electrodes GX₁ to GX_{N} (=G_{N+1} to G_{2N}) of the liquid crystal panel 220 within one vertical scanning period.

A circuit functionally equivalent to the signal driver 230 may be formed on the substrate on which the liquid crystal panel 220 is formed. A circuit functionally equivalent to the scan driver 240 may be formed on the substrate.

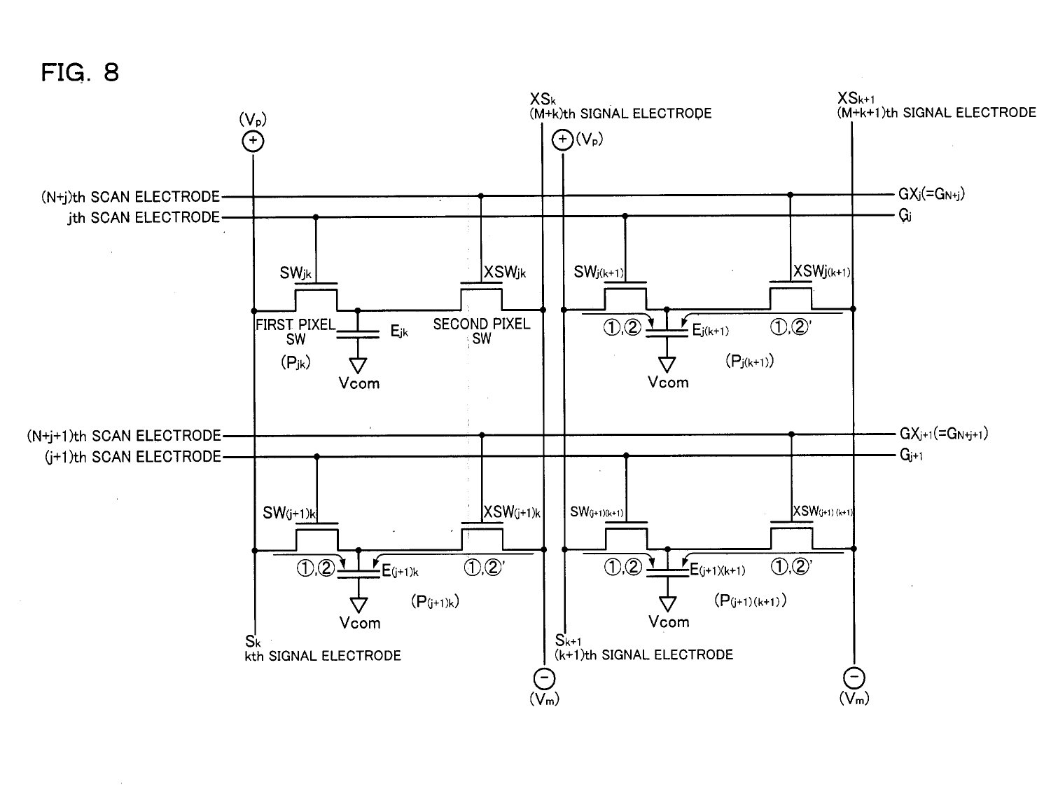

FIG. 8 is a configuration diagram of the pixels of the liquid crystal device in the second embodiment.

In FIG. 8, the pixels Pⱼₖ, Pⱼ₍ₖ₊₁₎, P₍ⱼ₊₁₎ₖ, and P₍ⱼ₊₁₎₍ₖ₊₁₎ are illustrated.

The pixel Pⱼₖ includes the first pixel switch element SWⱼₖ and the pixel electrode Eⱼₖ. The gate electrode of the first pixel switch element SWⱼₖ is connected with the jth scan electrode Gⱼ. The source terminal of the first pixel switch element SWⱼₖ is connected with the kth signal electrode Sₖ. The drain terminal of the first pixel switch element SWⱼₖ is connected with the pixel electrode Eⱼₖ. The first pixel switch element SWⱼₖ electrically connects the kth signal electrode Sₖ with the pixel electrode Eⱼₖ based on the voltage of the jth scan electrode Gⱼ.

The pixel Pⱼₖ may include the second pixel switch element XSWⱼₖ. The gate electrode of the second pixel switch element XSWⱼₖ is connected with the (N+j) th scan electrode GXⱼ (=G_{N+j}). The source terminal of the second pixel switch element XSWⱼₖ is connected with the (M+k) th signal electrode XSₖ (=S_{M+k}). The drain terminal of the second pixel switch element XSWⱼₖ is connected with the pixel electrode Eⱼₖ. The second pixel switch element XSWⱼₖ electrically connects the (M+k)th signal electrode XSₖ (=S_{M+k}) with the pixel electrode Eⱼₖ based on the voltage of the (N+j)th scan electrode GXⱼ (=G_{N+j}).

A liquid crystal capacitance is formed by sealing a liquid crystal between the pixel electrode Eⱼₖ and the common electrode opposite to the pixel electrode Eⱼₖ. The transmittance of the pixel is changed corresponding to the voltage applied between these electrodes. The common electrode voltage Vcom is supplied to the common electrode.

In this configuration, in the case of changing the voltage of the pixel electrode Eⱼₖ according to AC drive timing, the first and second pixel switch elements SWⱼₖ and XSWⱼₖ are turned ON by supplying the select signal to the jth and (N+j)th scan electrodes Gⱼ and GXⱼ (=G_{N+j}) in a first period of a given select period. This allows the pixel electrode Eⱼₖ to be electrically connected with the kth and (M+k) th signal electrodes Sₖ and XSₖ (=S_{M+k}). Therefore, the voltage of the pixel electrode Eⱼₖ is set at an intermediate voltage between the voltage Vp applied to the kth signal electrode Sₖ and the voltage Vm applied to the (M+k)th signal electrode XSₖ (=S_{M+k}). In AC drive, since the polarity of the voltage applied to the liquid crystal is reversed with respect to the common electrode voltage Vcom while maintaining the absolute value of the applied voltage the same, the intermediate voltage between the voltage Vp and the voltage Vm is the common electrode voltage Vcom (first voltage in a broad sense).

The first pixel switch element SWⱼₖ or the second pixel switch element XSWⱼₖ is turned ON by supplying the select signal to the jth scan electrode Gⱼ or the (N+j)th scan electrode GXⱼ (=G_{N+j), whereby the pixel electrode E}ⱼₖ is electrically connected with the kth signal electrode Sₖ or the (M+k) th signal electrode XSₖ (=S_{M+k}).

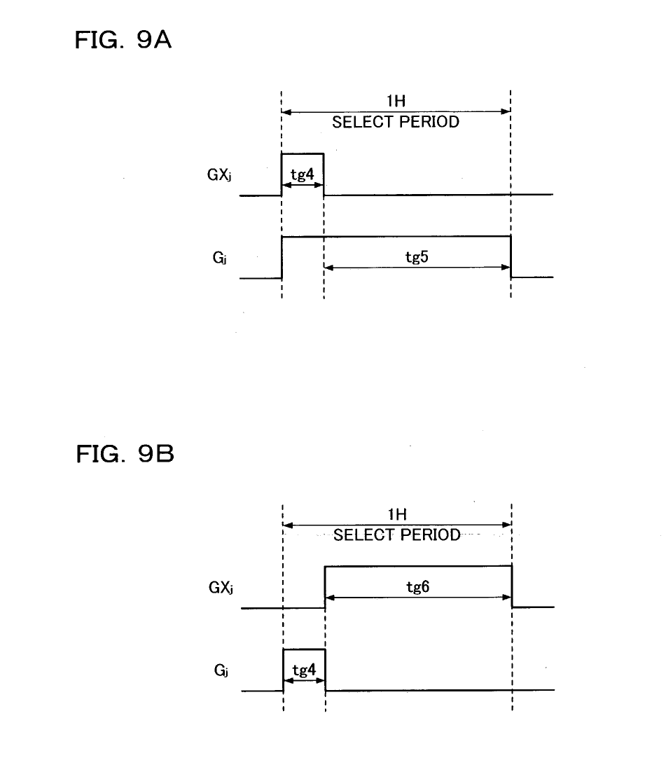

FIG. 9A shows a timing chart of the select signal supplied to each scan electrode in the case of changing the voltage applied to the liquid crystal of the pixel from negative to positive.

The select signal is supplied to the jth and (N+j)th scan electrodes Gⱼ and GXⱼ (=G_{N+j}) when one horizontal scanning period 1H (given select period in a broad sense) starts. The select signal having a pulse width of tg4 is supplied to the (N+j)th scan electrode GXⱼ (=G_{N+j}). The select signal having a pulse width of (tg4+tg5) is supplied to the jth scan electrode Gⱼ. This allows the first and second pixel switch elements SWⱼₖ and XSWⱼₖ to be turned ON, whereby the voltage of the pixel electrode Eⱼₖ is set at the common electrode voltage Vcom as described above.

When the time tg4 has elapsed after one horizontal scanning period is started, only the second pixel switch element XSWⱼₖ is turned OFF. This allows the voltage of the pixel electrode Eⱼₖ to be set at the voltage Vp of the kth signal electrode Sₖ through the first pixel switch element SWⱼₖ.

It is preferable that the pulse width tg4 be smaller than the pulse width tg5, taking drive capability for each electrode into consideration.

FIG. 9B shows a timing chart of the select signal supplied to each scan electrode in the case of changing the voltage applied to the liquid crystal of the pixel from positive to negative.

The select signal is supplied to the jth and (N+j)th scan electrodes Gⱼ and GXⱼ (=G_{N+j}) when one horizontal scanning period 1H (given select period in a broad sense) starts. The select signal having a pulse width of tg4 is supplied to the jth scan electrode Gⱼ. The select signal having a pulse width of (tg4+tg6) is supplied to the (N+j)th scan electrode GXⱼ (=G_{N+j}). This allows the first and second pixel switch elements SWⱼₖ and XSWⱼₖ to be turned ON, whereby the voltage of the pixel electrode Eⱼₖ is set at the common electrode voltage Vcom as described above.

When the time tg4 has elapsed after one horizontal scanning period is started, only the first pixel switch element SWⱼₖ is turned OFF. This allows the voltage of the pixel electrode Eⱼₖ to be set at the voltage Vm of the (M+k) th signal electrode XSₖ (=S_{M+k}) through the second pixel switch element XSWⱼₖ.

It is preferable that the pulse width tg4 be smaller than the pulse width tg6, taking drive capability for each electrode into consideration.

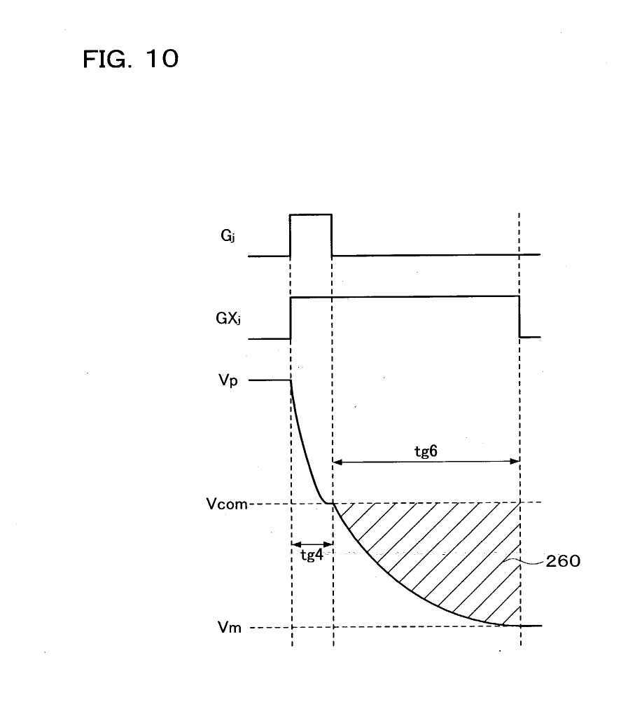

FIG. 10 schematically shows a change in voltage of the pixel electrode Eⱼₖ in the case of changing the voltage applied to the liquid crystal of the pixel from positive to negative.

The first and second pixel switch elements SWⱼₖ and XSWⱼₖ are turned ON when the select period starts, whereby the voltage of the pixel electrode Eⱼₖ is set at the common electrode voltage Vcom before the time tg1 elapses. Since only the first pixel switch element SWⱼₖ is then turned OFF, the voltage of the pixel electrode Eⱼₖ is set at the voltage Vm of the (M+k)th signal electrode XSₖ (=S_{M+k}).

Therefore, the pixel electrodes can be uniformly set at the common electrode voltage Vcom by only transferring charges in the liquid crystal panel 220 without allowing current from the outside to flow. Specifically, since it suffices that charges corresponding to slanted lines 260 be discharged, it is unnecessary to discharge the charges from the voltage Vp to the voltage Vm. This also applies to the case of changing the voltage from negative to positive. As described above, since it suffices that charges be charged or discharged from the common electrode voltage Vcom to either the voltage Vp or the voltage Vm, power consumption accompanied by AC drive can be decreased.

In addition, since it is unnecessary to perform inversion processing of the image data at AC drive timing in the signal driver 230 by separately providing the signal electrodes for positive and negative voltages, the configuration of the signal driver 230 can be simplified.

4. Third Embodiment

In the liquid crystal device in the first embodiment, in the case of reversing the polarity of the voltage applied to the liquid crystal according to AC drive timing, a decrease in power consumption is achieved by setting the applied voltage at the common electrode voltage Vcom by using the first to Mth electrodes SS₁ to SS_{M} to which the common electrode voltage Vcom is supplied, and then setting the applied voltage at either the voltage Vp or the voltage Vm. However, the present invention is not limited thereto. In a liquid crystal device in a third embodiment, the configuration of the liquid crystal panel is simplified by using one signal electrode in common to positive and negative voltages.

A liquid crystal device in the third embodiment is described below in detail.

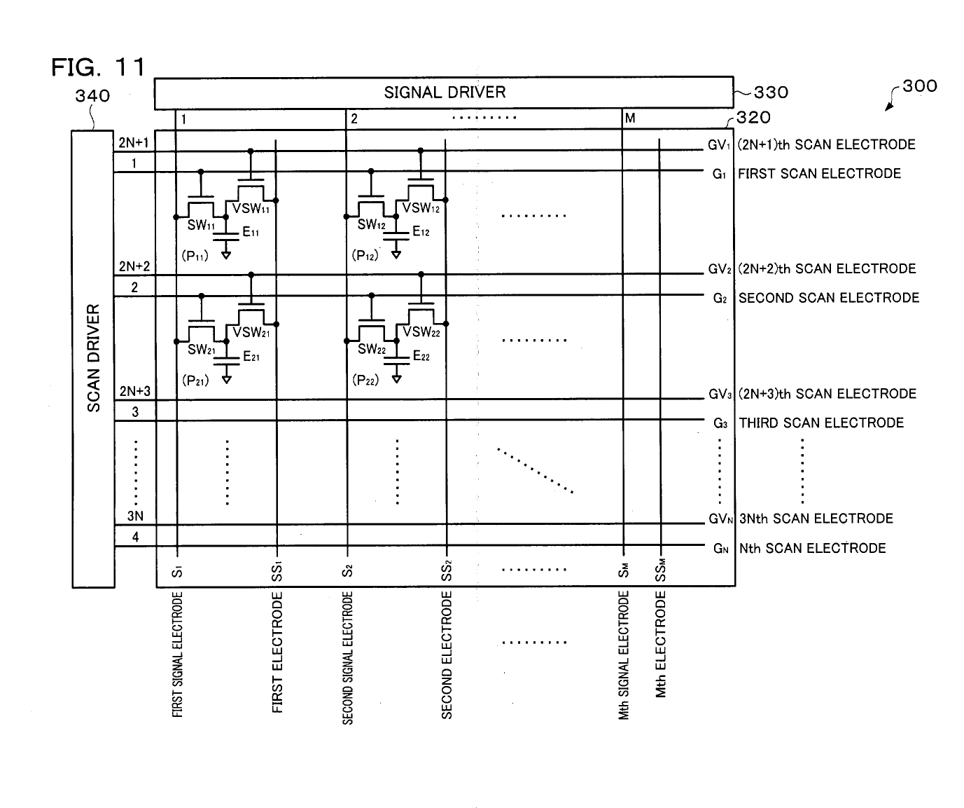

FIG. 11 shows an outline of a configuration of a liquid crystal device in the third embodiment.

A liquid crystal device 300 in the third embodiment may include a liquid crystal panel (display panel in a broad sense) 320.

A first feature of the liquid crystal panel 320 differing from the liquid crystal panel 120 of the liquid crystal device 100 in the first embodiment is that the (M+1) th to 2Mth signal electrodes XS₁, to XS_{M} (=S_{M+1} to S_{2M}) are removed. A second feature is that the (N+1)th to 2Nth scan electrodes GX₁ to GX_{N} (=G_{N+1} to G_{2N}) are removed. A third feature is that the second pixel switch elements XSW₁₁ to XSW_{NM} are removed from the pixels P₁₁ to P_{NM}. In the liquid crystal panel 320, the pixels (pixel regions) are disposed in the shape of a matrix corresponding to the intersecting points of the first to Nth scan electrodes G₁ to G_{N} and the first to Mth signal electrodes S₁ to S_{M} in the same manner as in the liquid crystal panel 120 in the first embodiment.

The pixel corresponding to the intersecting point of the j th scan electrode Gⱼ and the kth signal electrode Sₖ is indicated by Pⱼₖ. Although only the pixels P₁₁, P₁₂, P₂₁, and P₂₂ are illustrated in FIG. 11, other pixels have the same configuration.

The liquid crystal device 300 may include a signal driver 330. The signal driver 330 drives the first to Mth signal electrodes S₁ to S_{M} of the liquid crystal panel 320 based on image data. In the third embodiment, the voltage Vp at which the voltage applied to the liquid crystal becomes positive and the voltage Vm at which the voltage applied to the liquid crystal becomes negative are alternately supplied to the first to Mth signal electrodes S₁ to S_{M} according to AC drive timing.

The liquid crystal device 300 may include a scan driver 340. The scan driver 340 drives the first to Nth scan electrodes G₁ to G_{N} and the (2N+1)th to 3Nth scan electrodes GV₁ to GV_{N} (=G_{2N+1} to G_{3N}) of the liquid crystal panel 320 within one vertical scanning period.

A circuit functionally equivalent to the signal driver 330 may be formed on the substrate on which the liquid crystal panel 320 is formed. A circuit functionally equivalent to the scan driver 340 may be formed on the substrate.

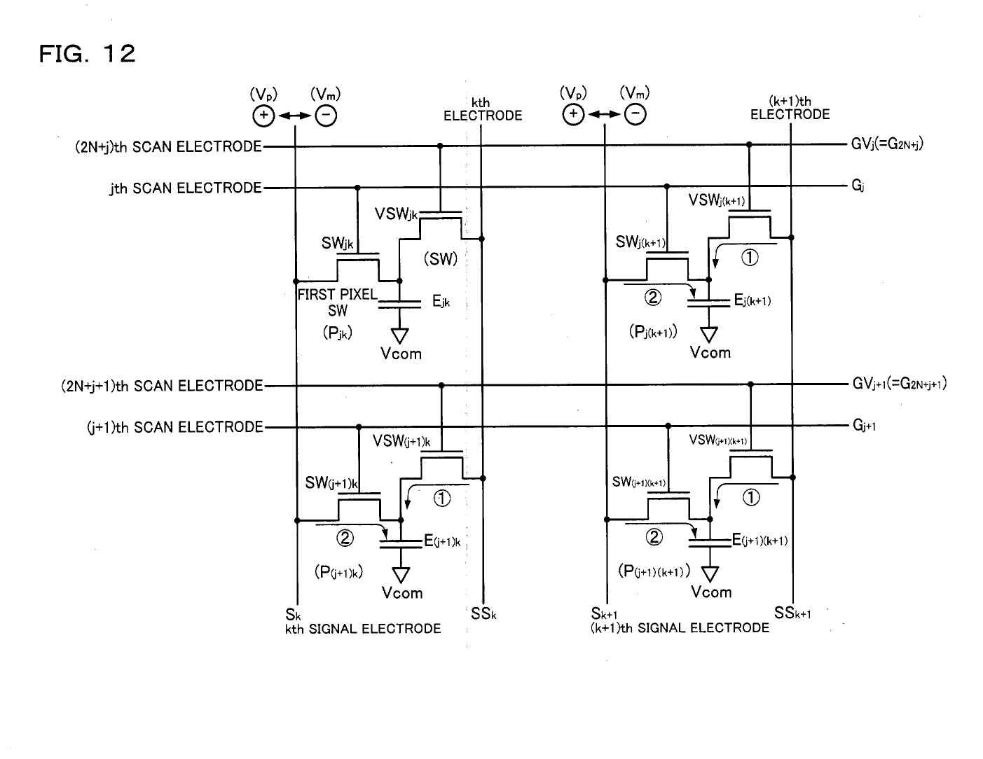

FIG. 12 is a configuration diagram of the pixels of the liquid crystal device in the third embodiment.

In FIG. 12, the pixels Pⱼₖ, Pⱼ₍ₖ₊₁₎, P₍ⱼ₊₁₎ₖ, and P₍ⱼ₊₁₎₍ₖ₊₁₎ are illustrated.

The pixel Pⱼₖ includes the first pixel switch element SWⱼₖ and the pixel electrode Eⱼₖ. The gate electrode of the first pixel switch element SWⱼₖ is connected with the jth scan electrode Gⱼ. The source terminal of the first pixel switch element SWⱼₖ is connected with the kth signal electrode Sₖ. The drain terminal of the first pixel switch element SWⱼₖ is connected with the pixel electrode Eⱼₖ. The first pixel switch element SWⱼₖ electrically connects the kth signal electrode Sₖ with the pixel electrode Eⱼₖ based on the voltage of the jth scan electrode Gⱼ.

The pixel Pⱼₖ may include the switch element VSWⱼₖ. The gate electrode of the switch element VSWⱼₖ is connected with the (2N+j)th scan electrode GVⱼ (=G_{2N+j}). The source terminal of the switch element VSWⱼₖ is connected with the kth electrode SSₖ. The drain terminal of the switch element VSWⱼₖ is connected with the pixel electrode Eⱼₖ. The switch element VSWⱼₖ electrically connects the kth electrode SSₖ with the pixel electrode Eⱼₖ based on the voltage of the (2N+j)th scan electrode GVⱼ (=G_{2N+j}).

A liquid crystal capacitance is formed by sealing a liquid crystal between the pixel electrode Eⱼₖ and the common electrode opposite to the pixel electrode Eⱼₖ. The transmittance of the pixel is changed corresponding to the voltage applied between these electrodes. The common electrode voltage Vcom is supplied to the common electrode.

In this configuration, in the case of changing the voltage of the pixel electrode Eⱼₖ according to AC drive timing, the switch element VSWⱼₖ is turned ON by supplying the select signal to the (2N+j)th scan electrode GVⱼ (=G_{2N+j}) in a first period of a given select period. This allows the pixel electrode Eⱼₖ to be electrically connected with the kth electrode SSₖ. Therefore, the voltage of the pixel electrode Eⱼₖ is set at the common electrode voltage Vcom (first voltage in a broad sense) applied to the kth electrode SSₖ.

The first pixel switch element SWⱼₖ is then turned ON by supplying the select signal to the jth scan electrode Gⱼ, whereby the pixel electrode Eⱼₖ is electrically connected with the kth signal electrode Sₖ.

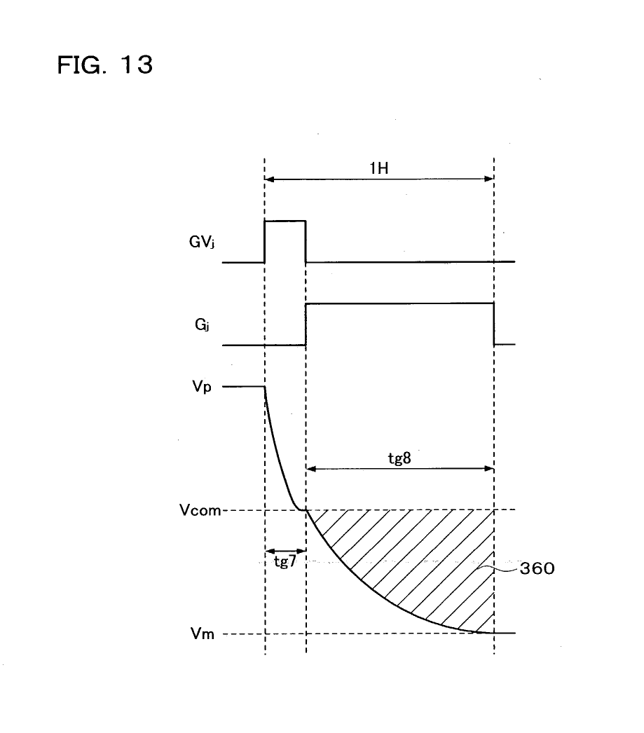

FIG. 13 schematically shows a change in voltage of the pixel electrode Eⱼₖ in the case of changing the voltage applied to the liquid crystal of the pixel from positive to negative.

The negative voltage Vm is supplied to the kth signal electrode Sₖ in the horizontal scanning period.

When the select period starts, the select signal having a pulse width of tg7 is supplied to the (2N+j) th scan electrode GVⱼ (=G_{2N+j}), whereby the switch element VSWⱼₖ is turned ON. This allows the voltage of the pixel electrode Eⱼₖ to be set at the common electrode voltage Vcom before the time tg7 elapses. The first pixel switch element SWⱼₖ is then turned ON by supplying the select signal having a pulse width of tg8 to the jth scan electrode Gⱼ, whereby the pixel electrode Eⱼₖ is electrically connected with the kth signal electrode Sₖ. Since the voltage Vm is applied to the kth signal electrode Sₖ in the horizontal scanning period, the pixel electrode Eⱼₖ is set at the voltage Vm.

Charges stored in all the pixels connected with one scan electrode are extracted into the common electrodes by allowing the first to Mth electrodes SS₁ to SS_{M} to be electrically connected with the common electrodes. Therefore, the pixel electrodes can be uniformly set at the common electrode voltage Vcom by only transferring charges in the liquid crystal panel 320 without allowing current from the outside to flow. Specifically, since it suffices that charges corresponding to slanted lines 360 be discharged, it is unnecessary to discharge the charges from the voltage Vp to the voltage Vm. This also applies to the case of changing the voltage from negative to positive. As described above, since it suffices that charges be charged or discharged from the common electrode voltage Vcom to either the voltage Vp or the voltage Vm, power consumption accompanied by AC drive can be decreased.

5. Electronic Equipment

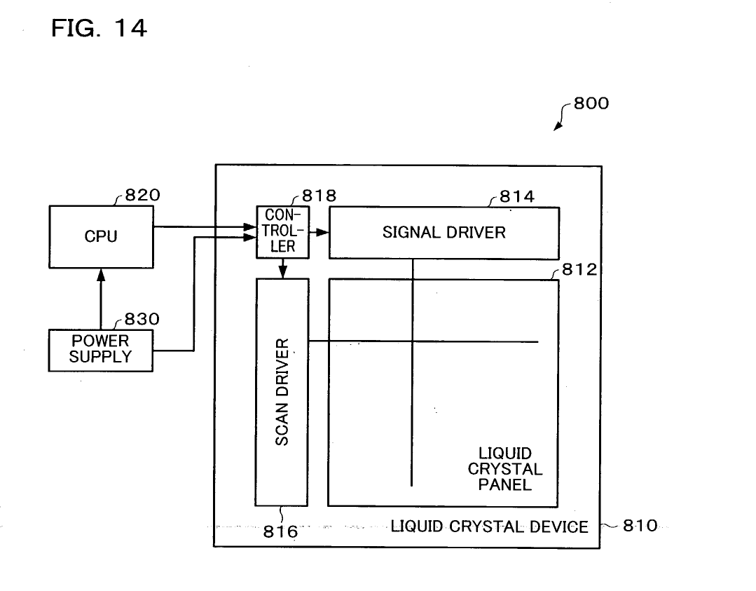

FIG. 14 shows an example of a functional block diagram of electronic equipment formed by using the liquid crystal device in the above embodiment.

Electronic equipment 800 includes a liquid crystal device 810, a CPU 820, and a power supply circuit 830. The CPU 820 generates image data according to a program stored in a RAM (not shown), and supplies the image data to the liquid crystal device 810. The power supply circuit 830 supplies given voltages to the liquid crystal device 810 and the CPU 820.

The liquid crystal device 810 includes a liquid crystal panel 812, a signal driver 814, a scan driver 816, and a controller 818. As the liquid crystal panel 812, any of the liquid crystal panels 120, 220, and 320 of the liquid crystal devices 100, 200, and 300 in the first to third embodiments may be employed.

The signal driver 814 drives the signal electrodes of the liquid crystal panel 812.

The scan driver 816 drives the scan electrodes of the liquid crystal panel 812.

The controller 818 controls the liquid crystal panel 812 by controlling the signal driver 814 and the scan driver 816 using the image data supplied from the CPU 820 according to timing instructed by the CPU 820.

As examples of electronic equipment having such a configuration, a liquid crystal projector, personal computer, pager, portable telephone, television, view finder or direct view finder video tape recorder, electronic notebook, electronic desk calculator, car navigation system, device provided with a POS terminal or a touch panel, and the like can be given.

The above embodiments are effective for a display device in which it is difficult to set the voltage required within the select period because one horizontal scanning period (1H) (select period in a broad sense) is short or the load of an interconnect capacitance and the like is great. For example, the above embodiments are effective in the case where the size of the display panel is large.

The above embodiments are described taking the case of using the common electrode voltage Vcom as the given first voltage as an example. However, the present invention is not limited thereto. An optional voltage between the voltage Vp and the voltage Vm may be used, taking drive capability of the signal electrode and the like into consideration.

The present invention is not limited to the above embodiments. Various modifications and variations are possible within the spirit and scope of the present invention. For example, the present invention can be applied to other display devices which perform AC drive.

The above embodiments are described taking the dot inversion drive method as an example of the AC drive method. However, the present invention can also be applied to the frame inversion drive method or the line inversion drive method. The present invention is not limited to the type of the inversion drive method.

What is claimed is:

1. A display device comprising:
first to Nth (N is an integer of two or more) scan electrodes;
first to Mth (M is an integer of two or more) signal electrodes intersecting the first to Nth scan electrodes;
pixels disposed corresponding to intersecting points of the first to Nth scan electrodes and the first to Mth signal electrodes;
(M+1) th to 2Mth signal electrodes disposed to form pairs with the first to Mth signal electrodes respectively;
(N+1)th to 2Nth scan electrodes disposed corresponding to the first to Nth scan electrodes; and
(2N+1)th to 3Nth scan electrodes disposed corresponding to the first to Nth scan electrodes,
wherein one of the pixels disposed corresponding to an intersecting point of a jth (1≦j≦N, j is an integer) scan electrode among the first to Nth scan electrodes and a kth (1≦k≦M, k is an integer) signal electrode among the first to Mth signal electrodes comprises:
a pixel electrode;
a first pixel switch element being connected with the jth scan electrode and the kth signal electrode, and electrically connecting the kth signal electrode with the pixel electrode based on a voltage of the jth scan electrode;
a second pixel switch element being connected with an (N+j) th scan electrode among the (N+1) th to 2Nth scan electrodes and an (M+k) th signal electrode among the (M+1)th to 2Mth signal electrodes, and electrically connecting the (M+k)th signal electrode with the pixel electrode based on a voltage of the (N+j)th scan electrode; and
a switch element being provided between a kth electrode and the pixel electrode, and electrically connecting the kth electrode with the pixel electrode based on a voltage of the (2N+j)th scan electrode, the kth electrode being disposed corresponding to the kth signal electrode and being supplied with a given first voltage, and
wherein a voltage of the pixel electrode is set at a voltage of the kth electrode through the switch element, and then set at a voltage of one of the kth and (M+k)th signal electrodes through one of the first and second pixel switch element in a given select period.

2. The display device as defined in claim 1,
wherein voltages supplied to the kth and (M+k)th signal electrodes are polarity-reversed on the basis of a potential of a common electrode provided facing to the pixel electrode.

3. A display device comprising:
first to Nth (N is an integer of two or more) scan electrodes;
first to Mth (M is an integer of two or more) signal electrodes intersecting the first to Nth scan electrodes;
pixels disposed corresponding to intersecting points of the first to Nth scan electrodes and the first to Mth signal electrodes;
(M+1) th to 2Mth signal electrodes disposed to form pairs with the first to Mth signal electrodes respectively; and
(N+1)th to 2Nth scan electrodes disposed corresponding to the first to Nth scan electrodes,
wherein one of the pixels disposed corresponding to an intersecting point of a jth (1≦j≦N, j is an integer) scan electrode among the first to Nth scan electrodes and a kth (1≦k≦M, k is an integer) signal electrode among the first to Mth signal electrodes comprises:
a pixel electrode;
a first pixel switch element being connected with the jth scan electrode and the kth signal electrode, and electrically connecting the kth signal electrode with the pixel electrode based on a voltage of the jth scan electrode; and
a second pixel switch element being connected with an (N+j) th scan electrode among the (N+1) th to 2Nth scan electrodes and an (M+k) th signal electrode among the (M+1) th to 2Mth signal electrodes, and electrically connecting the (M+k)th signal electrode with the pixel electrode based on a voltage of the (N+j)th scan electrode, and
wherein a voltage of the pixel electrode is set at a given intermediate voltage by turning ON the first and second pixel switch elements, and then set at a voltage of one of the kth and (M+k)th signal electrodes through one of the first and second pixel switch elements in a given select period.

4. The display device as defined in claim 3,
wherein voltages supplied to the kth and (M+k)th signal electrodes are polarity-reversed on the basis of a potential of a common electrode provided facing to the pixel electrode.

5. A display device comprising:
first to Nth (N is an integer of two or more) scan electrodes;
first to Mth (M is an integer of two or more) signal electrodes intersecting the first to Nth scan electrodes;
pixels disposed corresponding to intersecting points of the first to Nth scan electrodes and the first to Mth signal electrodes; and
(2N+1)th to 3Nth scan electrodes disposed corresponding to the first to Nth scan electrodes,
wherein one of the pixels disposed corresponding to an intersecting point of a jth (1≦j≦N, j is an integer) scan electrode among the first to Nth scan electrodes and a kth (1≦k≦M, k is an integer) signal electrode among the first to Mth signal electrodes comprises:
a pixel electrode;
a first pixel switch element being connected with the jth scan electrode and the kth signal electrode, and electrically connecting the kth signal electrode with the pixel electrode based on a voltage of the jth scan electrode; and
a switch element being provided between a kth electrode and the pixel electrode, and electrically connecting the kth electrode with the pixel electrode based on a voltage of the (2N+j)th scan electrode, the kth electrode being disposed corresponding to the kth signal electrode and being supplied with a given first voltage, and
wherein a voltage of the pixel electrode is set at a voltage of the kth electrode through the switch element, and then set at a voltage of the kth signal electrode through the first pixel switch element in a given select period.

6. The display device as defined in claim 1,
wherein the first voltage is substantially equal to a voltage applied to a common electrode provided facing to the pixel electrode.

7. The display device as defined in claim 2,
wherein the first voltage is substantially equal to a voltage applied to a common electrode provided facing to the pixel electrode.

8. The display device as defined in claim 5,
wherein the first voltage is substantially equal to a voltage applied to a common electrode provided facing to the pixel electrode.

9. Electronic equipment comprising the display device as defined in claim 1.

10. Electronic equipment comprising the display device as defined in claim 2.

11. Electronic equipment comprising the display device as defined in claim 3.

12. Electronic equipment comprising the display device as defined in claim 4.

13. Electronic equipment comprising the display device as defined in claim 5.

14. Electronic equipment comprising the display device as defined in claim 6.

15. Electronic equipment comprising the display device as defined in claim 7.

16. Electronic equipment comprising the display device as defined in claim 8.

17. A method of driving a display device, the display device including:
first to Nth (N is an integer of two or more) scan electrodes;
first to Mth (M is an integer of two or more) signal electrodes which intersect the first to Nth scan electrodes;
pixel electrodes disposed corresponding to intersecting points of the first to Nth scan electrodes and the first to Mth signal electrodes; and
first pixel switch elements electrically connecting the first to Mth signal electrodes with the pixel electrodes based on voltages of the first to Nth scan electrodes,
the method comprising:
setting one of the pixel electrodes of a pixel disposed corresponding to an intersecting point of a jth (1≦j≦N, j is an integer) scan electrode among the first to Nth scan electrodes and a kth (1≦k≦M, k is an integer) signal electrode among the first to Mth signal electrodes at a first voltage, and then setting the pixel electrode of the pixel at a voltage of the kth signal electrode based on a voltage of the jth scan electrode in a given select period.
